(19) United States
(12) Patent Application Publication
(10) Pub. No.: US 2005/0082439 A1
(43) Pub. Date: Apr. 21, 2005

(54) DISPLAY DEVICE WITH A MARKING BOARD

(76) Inventor: Heng-Chun Ho, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,654

(22) Filed: Oct. 15, 2003

(51) Int. Cl. F16L 3/00

(52) U.S. Cl. 248/121

(57) ABSTRACT

A display device includes a display and a display base. The display base includes a housing and a marking board installed inside the housing and connected to the housing in a detachable manner. The marking board is detachable, and can be swapped by users for using a personal mark. The display base also includes a luminous module installed inside the housing of the display base for lighting the marking board.

### BACKGROUND OF INVENTION

1. Field of the Invention

The present invention relates to a display device, and more specifically, to a display device with a marking board inside a display base.

2. Description of the Prior Art

Nowadays computer technology and the internet are developing very fast and are changing the lives of people. Displays are more and more important for people, and allow people to view information from the internet on the displays. Nowadays, the technology of displays develops very fast from the traditional monitor to the liquid crystal display (LCD) and the plasma display with advanced technology. The LCD and plasma displays are implemented in domestic electric appliances now, like the LCD TV and plasma TV, and they have advantages of light weight, thin thickness, large-sized, wide angle of vision, high-speed reaction, and high image quality, and so on. So they will substitute for traditional color televisions and many manufacturers are looking forward to the latent capacity of the products.

However if the conventional display device includes a base, the base is always only designed for the supporting the display and the outward appearance of the base always lack of variations. The lack of a unique outward appearance is a pity especially with the trend that industrial design and personal products are emphasized. If an ingenious design can be applied on the attached base of the display device, the display device can be endowed with a special vitality and designed for suiting various personalities.

### SUMMARY OF INVENTION

It is therefore a primary objective of the present invention to provide a display device with a marking board inside a display base to solve the problems mentioned above.

Briefly summarized, a display device includes a display and a display base. The display base includes a housing and a marking board installed inside the housing and connected to the housing in a detachable manner.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a display device according to the present invention.

FIG. 2 is a diagram of a display installed on a display base.

FIG. 3 is a front view of the display base.

FIG. 4 is a diagram of a luminous module installed on the display base.

FIG. 5 is a sectional drawing of the display base along the axis 5-5′.

FIG. 6 is a sectional drawing of the display base along the axis 6-6′.

FIG. 7 is an outward drawing of a marking board.

### DETAILED DESCRIPTION

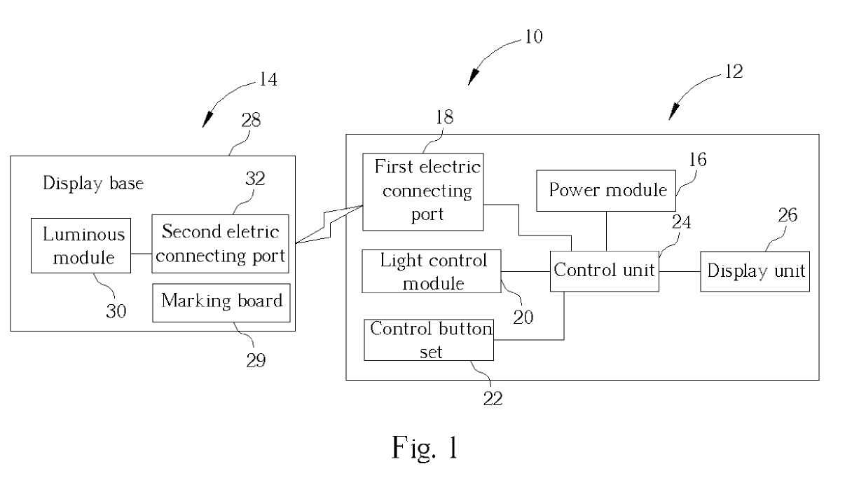

Please refer to FIG. 1. FIG. 1 is a block diagram of a display device 10 according to the present invention. The display device 10 includes a display 12 for displaying image data and a display base 14 for supporting the display 12. The display 12 can be a plasma television or an LCD television.

The display 12 includes a power module 16 for transferring the external electric power to the operating electric power of the display 12, a first electric connecting port 18 for transmitting the electric power of the display 12 to the display base 14, a light control module 20 for controlling the electric power transmitted from the first electric connecting port 18 to the display base 14, and a control button set 22 installed on the housing of the display 12 for allowing users to input a control signal for adjusting settings such as hue, brightness, and contrast of the image. The display 12 further includes a control unit 24 electrically connected to the power module 16, the first electric connecting port 18, the light control module 20, and the control button set 22 for controlling the display 12. In addition, the display 12 contains a display unit 26 for receiving image data from the control unit 24 and displaying the image data.

The display base 14 includes a housing 28 for covering components inside the display base 14, a marking board 29 installed inside the housing and connected to the housing 28 in a detachable manner, and a luminous module 30 installed inside the housing 28 for lighting the marking board. The luminous module 30 can include a plurality of light-emitting diodes (LED) for emitting the light or include a fluorescent body for receiving the energy of light from the external light source and releasing the energy of light in a dark situation. The display base 14 further includes a second electric connecting port 32 for connecting with the first electric connecting port 18 of the display 12 and transmitting the electric power from the display 12 to the luminous module 30 of the display base 14 to supply the operating electric power of the luminous module 30.

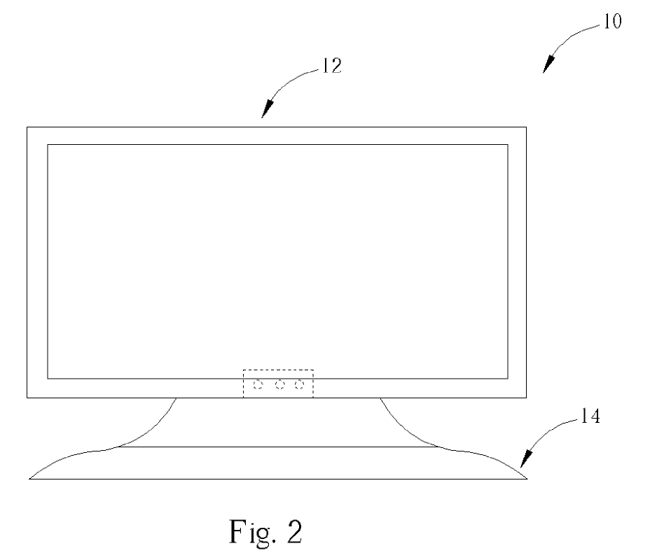

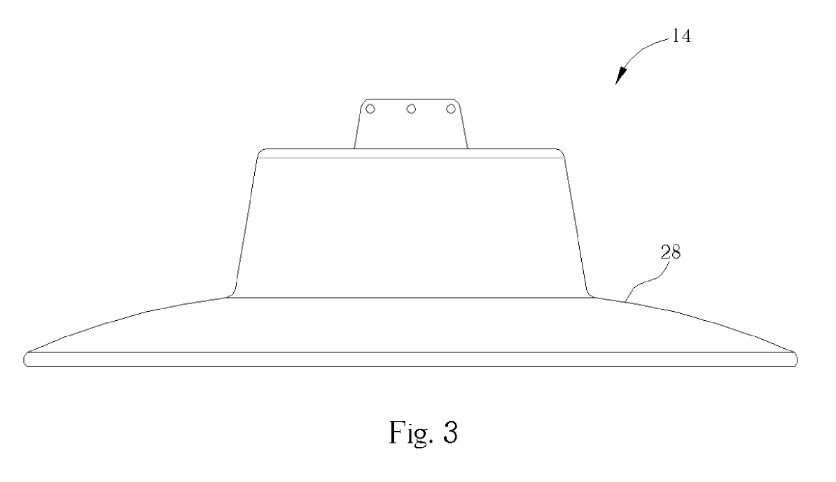

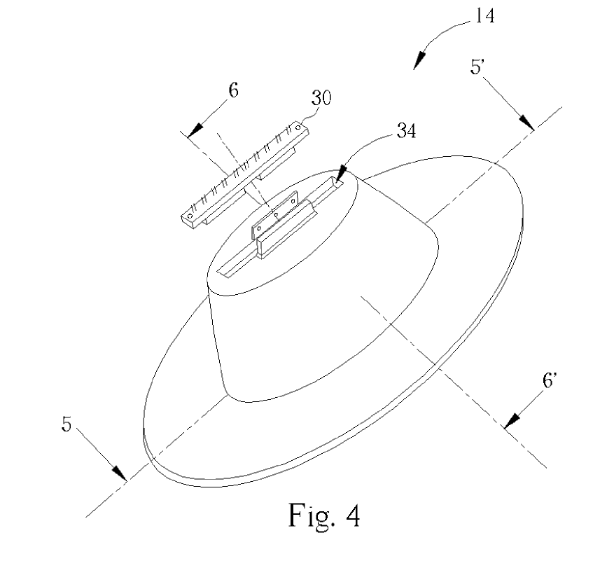

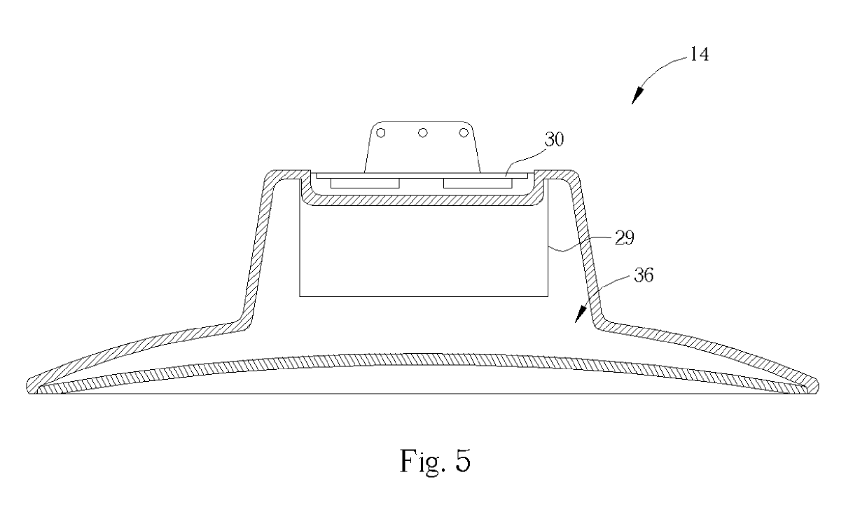

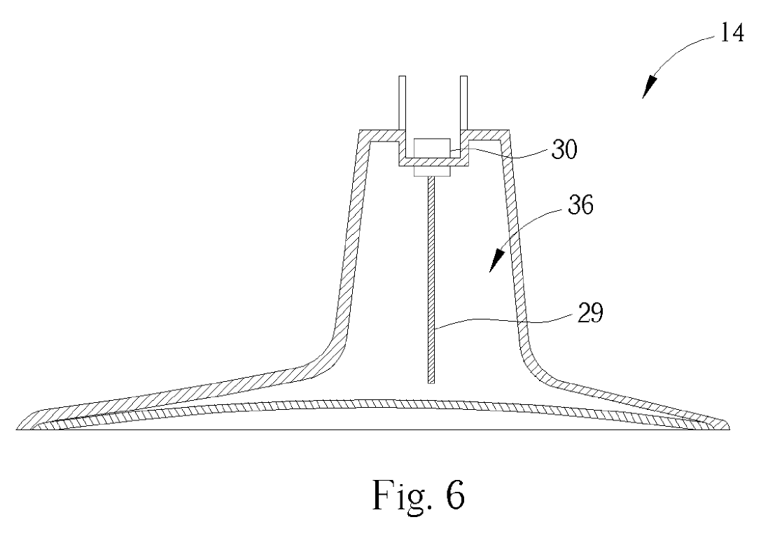

Please refer to FIG. 2. FIG. 2 is a diagram of the display 12 installed on the display base 14. The display 12 can be locked on the displat base 14 and the display base 14 must be able to support the display 12. Please refer to FIG. 3. FIG. 3 is a front view of the display base 14. The housing 28 of the display base 14 is made of wear-resisting material and can be made of transparent material. Please refer to FIG. 4. FIG. 4 is a diagram of the luminous module 30 installed on the display base 14. The luminous module 30 can be formed in a strip shape, and there are an array of light-emitting diodes installed on the luminous module 30. The display base 14 includes a groove 34. The luminous module 30 can be inserted into the groove 34 and emit light to the bottom of the display base 14. Please refer to FIG. 5 and FIG. 6. FIG. 5 is a sectional drawing of the display base 14 along the axis 5-5′. FIG. 6 is a sectional drawing of the display base 14 along the axis 6-6′. There is a hollow room 36 inside the display base 14. The marking board 29 is installed inside the hollow room 36 and connected to the housing 28 under the luminous module 30 in a detachable manner. Users or designers can substitute the marking board 29 with other designs and patterns. The light emitted from the luminous module 30 to the bottom of the display base 14 can illuminate the marking board 29 and disperse to the housing 28 around the hollow room 36 and finally to a users eyes. So the user can see the marking board 29 with projecting light. The light-emitting diodes of the luminous module 30 can emit colored light or the transparent material of the housing 28 or the marking board 29 can be colored, which is for presenting the colorful pattern and the light emitted from the display base 14.

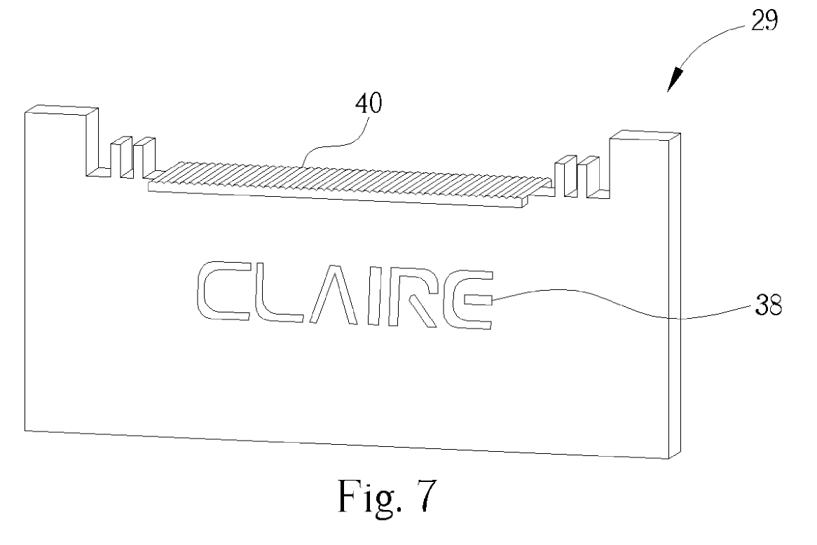

Please refer to FIG. 7. FIG. 7 is an outward drawing of the marking board 29. The marking board 29 can be made of transparent material. There is a pattern 38 on the marking board. The pattern 38 can be a word or a figure, and the pattern 38 can be made from a notch of the marking board 29 or a flange of the marking board 29. And the pattern 38 can include a mist surface for refracting light emitted by the luminous module 30 better, and the transparent material of the housing 28 also can highlight the luminous effect of the pattern 38. The marking board 29 includes a plurality of nicks 40 on the top surface of the marking board 29 for dispersing the light emitted from the luminous module 30 and can enhance the astigmatic effect of the light emitted from the luminous module 30.

The working principle of the present invention is as follows. The display 12 can receive the external electric power by the power module 16 and supply the operating electric power to the display 12. The electric power can be transmitted to the display base 14 by the connection of the first electric connecting port 18 and the second electric connecting port 32. The light control module 20 can control the electric power transmitted from the first electric connecting port 18 to the display base 14 so as to control the brightness of the light emitted by the luminous module 30. Users can use the control button set 22 to control the settings of the light control module 20, like the brightness of the light. The light emitted from the luminous module 30 to the bottom of the display base 14 can illuminate the marking board 29. The plurality of nicks 40 on the top surface of the marking board 29 can disperse the light emitted from the luminous module 30, and then the light passes through the medium of the marking board 29 and illuminates the pattern 38 of the marking board 29. If the marking board 29 and the housing 28 are made of transparent material, users can see the pattern 38 of the marking board 29 forming in projected light. If the luminous module 30 can emit colored light or the transparent material of the housing 28 or the marking board 29 are colored, a colorful pattern will be presented. Additionally, when the display unit 26 of the display 12 is displaying image data, the light control module 20 can control less electric power to be transmitted from the first electric connecting port 18 to the display base 14 so as to lower the brightness of the light emitted by the luminous module 30. And when the display unit 26 is not displaying image data, the power module 16 still continues receiving the external electric power for providing the electric power to the luminous module 30 and the light control module 20 can control the more electric power transmitted from the first electric connecting port 18 to the display base 14 so as to increase the brightness of the light emitted by the luminous module 30 for providing the lighting function.

Additionally, the display base 14 can further include a power supply module for providing the electric power to the luminous module 30. The manner of providing the electric power can be through receiving the external electric power or installing batteries instead of receiving the electric power from the first electric connecting port 18. The working principle is the same as mentioned above, so the detailed description is omitted.

The display base 14 of the display device 10 need not include the luminous module 30, that is, the display base 14 would not illuminate the marking board 29. And the pattern 38 on the marking board 29 also can be presented and not be influenced by the lack of light.

In contrast to the prior art, the present invention provides a detachable marking board installed inside the display base. The marking board can be swapped by users for using a personal mark. So the display device can be modified to suit personalities, and the aesthetic feeling of the outward appearance can be increased. The display device also can be an important decoration at home. The present invention can improve the aesthetic feeling and artistic value of the display device and design for a personal product. Therefore the present invention can add value to the conventional display device.

Those skilled in the art will readily observe that numerous modifications and alterations of the device may be made while retaining the teachings of the invention. Accordingly, the above disclosure should be construed as limited only by the metes and bounds of the appended claims.

1. A display device comprising:
a display; and
a display base comprising:
a housing; and
a marking board installed inside the housing and connected to the housing in a detachable manner.

2. The display device of claim 1 wherein a pattern is formed on the marking board.

3. The display device of claim 2 wherein the pattern includes a mist surface.

4. The display device of claim 2 wherein the pattern is made from a notch of the marking board.

5. The display device of claim 2 wherein the pattern is made from a flange of the marking board.

6. The display device of claim 1 wherein the display base further comprises a luminous module installed inside the housing of the display base for lighting the marking board.

7. The display device of claim 6 wherein the marking board comprises a plurality of nicks for dispersing the light emitted from the luminous module.

8. The display device of claim 6 wherein the luminous module comprises a plurality of light-emitting diodes (LED).

9. The display device of claim 6 wherein the display comprises a first electric connecting port and the display base further comprises a second electric connecting port for connecting to the first electric connecting port and receiving electric power from the display to supply operating electric power of the luminous module.

10. The display device of claim 6 wherein the display further comprises a light control module for controlling the energy of light emitted by the luminous module.

11. The display device of claim 1 wherein the display is a plasma television.

12. The display device of claim 1 wherein the display is an LCD television.

13. The display device of claim 1 wherein the housing of the display base is made of transparent material.

14. The display device of claim 1 wherein the housing of the display base is made of wear-resisting material.

15. The display device of claim 1 wherein the display base further comprises a power module for supplying electric power for the luminous module.
